(19) United States
(12) Patent Application Publication
(10) Pub. No.: US 2002/0048383 A1
(43) Pub. Date: Apr. 25, 2002

(54) Electrostatic transducer

(76) Inventor: Richard Pribyl, Fischamend (AT)

Correspondence Address: FRIEDRICH KUEFFNER, PATENT AND TRADEMARK ATTORNEY, SUITE 1921, 342 MADISON AVENUE, NEW YORK, NY, 10173, US

(21) Appl. No.: 09/976,264

(22) Filed: Oct. 12, 2001

(30) Foreign Application Priority Data
Oct. 16, 2000 (AT) A 1766/2000

(51) Int. Cl. H04R 11/04

(52) U.S. Cl. 381/355; 381/361

(57) ABSTRACT

An electrostatic transducer of small size, particularly having a diameter of 2-30 mm, is provided with a metal housing or electrically conductive housing having at least one front sound entry opening and a print arranged on a rear side of the housing, wherein the print substantially closes off the housing and has at least one rear sound entry opening, and wherein an electronic system is arranged on the inner side of the print. The at least one rear sound entry opening is formed at the periphery of the print. The print may be star-shaped or may have a polygonal shape.

### BACKGROUND OF THE INVENTION

1. Field of the Invention

The invention relates to an electrostatic transducer of small size, particularly an electrostatic transducer having a diameter of 2-30 mm. The transducer has a metal or electrically conductive housing with at least one front sound entry opening and a print which essentially closes off the rear side of the housing and is provided with at least one rear sound entry opening, wherein an electronic unit is arranged at the inner side of the print.

2. Description of the Related Art

Electrostatic transducers of the above-described type are used in mobile transmitting units, such as wireless telephones, mobile telephones, hands-free systems for automobile telephones, sensors, for example, for a speed-dependent volume control in car radios. The electrostatic transducers are either electrostatic transducers with integrated impedance transformers or integrated impedance transformers with subsequent amplifiers.

Electret capsules having the configuration briefly described above are known in the art for use for the above-mentioned purposes. Since these capsules are used in connection with transmitters, there is the problem of high frequency interference entering into the interior of the capsule where active electronic components are located. If high frequency interference penetrates into the electronic system, the non-linear behavior of the high frequency results in demodulations and cross modulations. As a result of the configuration of the known transducers, the high frequency enters through the acoustic openings at the front sound entry and especially at the rear sound entry through holes of the print which closes off the capsule. The high frequency interference also enters the interior bound to wires through the electrical connections.

The disturbance resulting from the high frequency interference results acoustically in humming or radio reception and may be so dominant that the speech or signal transmission becomes unintelligible.

### SUMMARY OF THE INVENTION

It is the primary object of the present invention to avoid the disadvantages described above and to provide an electrostatic transducer which operates without disturbance even in an area having high frequency interference.

In accordance with the present invention, the rear sound entry openings in the print are formed by at least one recess at the rim of the print. In other words, with the capsule having a circular shape, the circumference of the print has at least partially a star-shaped or polygonal shape.

As a result of the feature according to the present invention, at least one entry opening for the high frequency interference is shifted outwardly, so that the screening effect of the metal or electrically conductive capsule housing is additionally utilized. Since the electronic system of the capsule is always arranged in the center thereof, the measure according to the present invention also increases the distance between the high frequency entry and the electronic system, so that the magnitude of the influence of the high frequency is reduced.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective bottom view of a capsule according to the prior art;

FIG. 2 is a sectional view of the capsule of FIG. 1;

FIG. 3 is a perspective exploded bottom view of the capsule according to the present invention and of a print according to the present invention;

FIG. 4 is a sectional view of the capsule of FIG. 3; and

FIGS. 5 and 6 are bottom perspective views of additional embodiments of the print according to the present invention.

### DESCRIPTION OF THE PREFERRED EMBODIMENTS

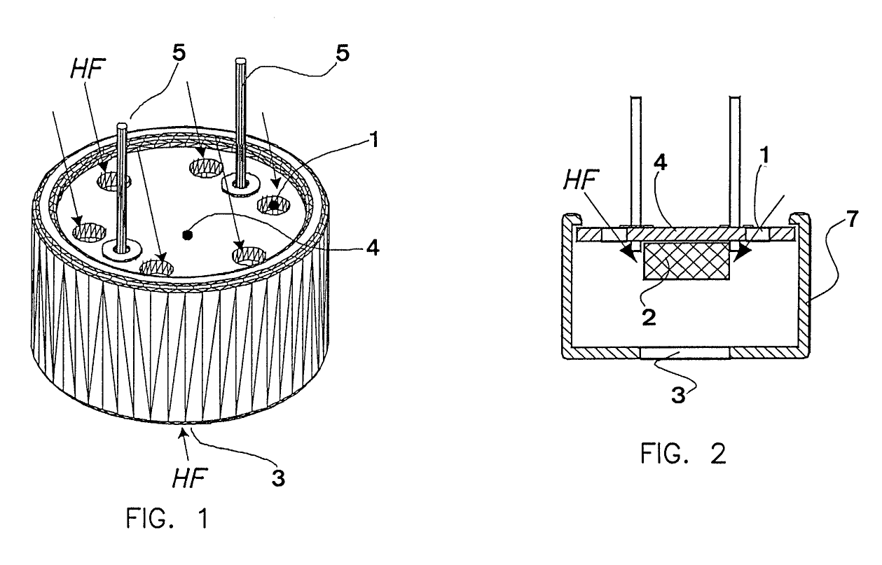

FIGS. 1 and 2 of the drawing show a typical electret capsule according to the prior art and they show particularly the paths along which the high frequency interference enters. Electronic components 2 of the capsule are arranged on a print 4. The corresponding electrical connections 5 extend out of the capsule through appropriate openings, wherein usually several rear sound entry openings 1 are arranged adjacent the openings for the electrical connections 5. A front sound entry opening 3 is located on the front side of the capsule. The capsule housing 7 is usually of a metal material or an electrically conductive material.

The paths along which the high frequency interference enters is indicated in FIGS. 1 and 2 by arrows HF; in addition, as already mentioned, the high frequency interference also enters bound to wires through the conductors 5. Despite these various disturbances, the high frequency interference entering through the rear sound entry openings 1 remains the principal problem.

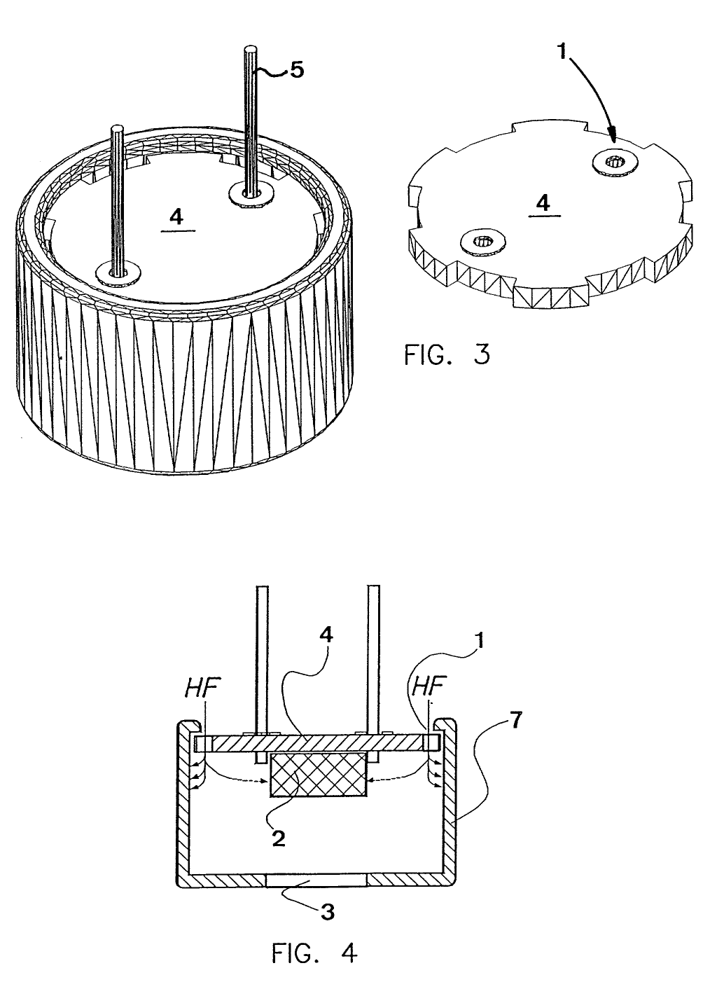

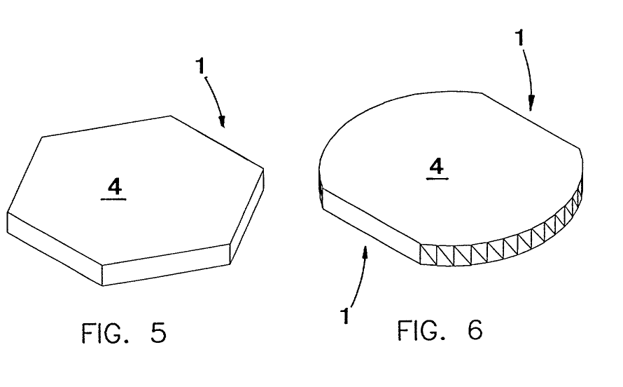

In accordance with the present invention, due to the configuration of the print 4 in the form shown in FIG. 3, the effects of the high frequency interference entering through the rear sound entry openings is significantly reduced. The individual sound entry openings 1 are located at the periphery of the print 4 and, thus, are arranged significantly farther away from the electronic unit 2 than in the past. In addition, due to the proximity to the housing 7, a large portion of the entering high frequency interference is conducted toward the capsule housing, so that the effects of the measure according to the present invention are surprisingly significantly greater than could be expected by the shift of the openings alone.

Since the rear sound entry openings 1 are now no longer holes which penetrate the outer side of the print 4, it is possible in accordance with a further embodiment of the present invention to provide an electrically conductive screen surface which substantially covers the print and is connected to mass. This causes the high frequency interference to be practically completely screened on the rear side of the capsule and the entry of the high frequency interference is limited to the front sound entry opening 3 which, however, has a relatively large distance from the electronic system.

The invention is not limited to the embodiments discussed above; rather, various modifications are possible. For example, the print may also have the form of a disc with a segment cut out of the disc.

While specific embodiments of the invention have been described in detail to illustrate the inventive principles, it will be understood that the invention may be embodied otherwise without departing from such principles.

I claim:

1. An electrostatic transducer comprising a metal housing or electrically conductive housing having at least one front sound entry opening and a print for essentially closing off a rear side of the housing, wherein the print has at least one rear sound entry opening, wherein an electronic unit is arranged on an inner side of the print, and wherein the at least one rear sound entry opening is located at and formed by a periphery of the print.

2. The electrostatic transducer, wherein the housing has a diameter of 2-30 mm.

3. The electrostatic transducer according to claim 1, wherein the print is star-shaped.

4. The electrostatic transducer according to claim 1, wherein the print has a polygonal shape.

5. The electrostatic transducer according to claim 1, wherein the print is disc-shaped having a segment cut out of the disc.

6. The electrostatic transducer according to claim further comprising an essentially closed plate of electrically conductive material attached to the print, wherein the plate covers the print and is electrically connected to mass.
